(19) United States
(12) Patent Application Publication
(10) Pub. No.: US 2014/0374618 A1
(43) Pub. Date: Dec. 25, 2014

(54) ULTRAVIOLET WATER TREATMENT DEVICE

(71) Applicant: Kabushiki Kaisha Toshiba, Tokyo (JP)

(72) Inventors: Takeshi IDE, Tokyo (JP); Norimitsu ABE, Kawasaki (JP); Seiichi MURAYAMA, Tokyo (JP); Shinji KOBAYASHI, Tokyo (JP); Kenji TAKEUCHI, Tokyo (JP); Takahiro SOMA, Tokyo (JP)

(21) Appl. No.: 14/479,199

(22) Filed: Sep. 5, 2014

Related U.S. Application Data
(63) Continuation of application No. PCT/JP2013/052029, filed on Jan. 30, 2013.

(30) Foreign Application Priority Data
Mar. 8, 2012 (JP) 2012-052150

(51) Int. Cl. C02F 1/32

(52) U.S. Cl. CPC C02F 1/325; C02F 2201/324; C02F 2201/3227
USPC 250/431

(57) ABSTRACT

An ultraviolet water treatment device of an embodiment includes an ultraviolet irradiation tank. The ultraviolet irradiation tank includes a plurality of ultraviolet irradiation modules. The ultraviolet irradiation modules include a plurality of lines of ultraviolet irradiation pipes, a cleaning device and a cleaning device driving unit. The ultraviolet irradiation pipes include a plurality of lines of ultraviolet lamps and a plurality of lines of ultraviolet lamp protective pipes individually protecting the ultraviolet lamps. The cleaning device cleans a surface of each ultraviolet lamp protective pipe. Each ultraviolet irradiation module includes two or three ultraviolet irradiation pipes.

### CROSS-REFERENCE TO RELATED APPLICATIONS

This is a Continuation Application of PCT application No. PCT/JP2013/052029, filed on Jan. 30, 2013, which was published under PCT Article 21(2) in Japanese.

This application is based upon and claims the benefit of priority from Japanese Patent Application No. 2012-52150, filed on Mar. 8, 2012; the entire contents of which are incorporated herein by reference.

### FIELD

Embodiments described herein relate generally to an ultraviolet water treatment device.

### BACKGROUND

An ultraviolet ray has an effect such as sterilization, disinfection, decolorization, and deodorization of water, or bleaching of pulp. In addition, the ultraviolet ray has a characteristic capable of immediately coping by adjusting power of a lamp with respect to change of water quality and water quantity. For this reason, in order to perform sterilization, disinfection, and decolorization of water supply and drainage, deodorization and decolorization of industrial water, or bleaching of pulp, there is a case of using an ultraviolet water treatment device.

As an ultraviolet water treatment device in the related art, for example, three representative types are known.

As the first type, a structure is known in which a cylindrical water flow body and a cylindrical lamp housing of the same diameter as that of the water flow body are joined to cross, and a plurality of ultraviolet irradiation pipes formed of quartz glass housing an ultraviolet lamp therein are mounted in parallel to a lamp housing axis in the lamp housing. Since the ultraviolet water treatment device of the first type may be directly installed in a treated water main pipe of a water treatment facility, extra branched and confluent pipes are not necessary, and thus there is an advantage of reducing an installation space. On the other hand, in the ultraviolet water treatment device of the first type, lengths or the number of ultraviolet lamps are restricted for a compact structure. For this reason, when the ultraviolet water treatment device of the first type is used for the purpose other than design specifications, there is an inconvenience that an expansion pipe or a reduction pipe for installation is necessary since a water flow body diameter is too larger or too small with respect to treatment flow quantity, and there is an inconvenience that an ultraviolet irradiation amount is insufficient since the number of housed lamps is restricted.

As a second type, a structure is known in which a cylindrical water flow body and a lamp housing configured by a circular pipe with a diameter smaller than the water flow body are joined to cross, a plurality of ultraviolet irradiation pipes formed of quartz glass housing an ultraviolet lamp therein are mounted in parallel to a lamp housing axis in the lamp housing. In the ultraviolet water treatment device of the second type, even when the water flow pipe diameter is large and further a necessary ultraviolet amount is different, it is possible to appropriately increase and decrease the number of lamp housings, and thus there is an advantage that it is suitable for a relatively large scale treatment facility. On the other hand, when the ultraviolet water treatment device of the second type is used in a treatment facility requiring a large ultraviolet irradiation amount with a small treatment amount, similarly, the water flow body pipe diameter of the ultraviolet water treatment device is too large or too small with respect to the treated water main pipe diameter of the treatment facility, and thus there is an inconvenience that an expansion pipe or a reduction pipe for installation is necessary and an excessive installation space is necessary.

As a third type, a structure is known in which irradiation pipes of a plurality of lines housing an ultraviolet lamp in a quartz glass pipe are arranged in a rectangular ultraviolet irradiation body in a direction perpendicular to a flow direction of the treated water, a plurality of irradiation pipe rows with the same structure are disposed in the flow direction, a cross-section shape change connection unit that connects a circular cross-section of the treated water main pipe diameter of the applied treatment facility to a rectangular cross-section of a rectangular ultraviolet irradiation body with a rectangular cross-section while changing the cross-sectional shape is provided as an inlet and an outlet of the treated water. In the ultraviolet water treatment device of the third type, there are an advantage that it is possible to increase the number of stages of the irradiation pipe rows constituting the ultraviolet irradiation body according to the necessary ultraviolet irradiation amount, and an advantage that it is possible to change the inlet and the outlet according to the pipe diameter of the facility. However, in the third type, there is an inconvenience that the cross-sectional shape changing and connecting unit for connecting the facility pipe diameter to the rectangular ultraviolet irradiation body increases the installation space of the ultraviolet water treatment device.

As described above, in the representative ultraviolet water treatment device of the related art, there is a case where a convenience requiring excessive large installation space occurs by the expansion pipe, the reduction pipe, or the cross-sectional shape change and connection unit.

As a technique which can resolve the convenience, an ultraviolet water treatment device is known. The ultraviolet water treatment device includes an ultraviolet lamp unit that is provided with first piping flange joints on both ends and is provided with an ultraviolet irradiation pipe including an ultraviolet lamp and a lamp protective pipe protecting the ultraviolet lamp therein, and a cleaning device driving unit that is provided with second piping flange joints on both ends and drives a cleaning device cleaning a surface of the lamp protective pipe. The ultraviolet lamp unit and the cleaning device driving unit of the ultraviolet water treatment device are connected at the first and second piping flange joint portions.

In the ultraviolet water treatment device, even when the water type or water quantity is changed, it is possible to simply exchange the ultraviolet lamp unit to a separate ultraviolet lamp unit, and there is an advantage that it is possible to easily introduce the ultraviolet water treatment device into the existing water treatment facility. For example, in a facility requiring three ultraviolet irradiation pipes, one ultraviolet lamp unit including three ultraviolet irradiation pipes is provided, and in a facility requiring six ultraviolet irradiation pipes, two ultraviolet lamp units including three ultraviolet irradiation pipes are provided.

The ultraviolet water treatment device has any problem. However, according to study of the inventor, there is room for improvement in the point how a just enough number of ultraviolet irradiation pipes with respect to conditions of treated water (the water type and water quantity) are provided. Specifically, in a facility requiring the number of ultraviolet irradiation pipes other than multiplies of 3, there is room for improvement in the point how the ultraviolet lamp units are provided. For example, the facility requiring two ultraviolet irradiation pipes is provided with one ultraviolet lamp unit including two ultraviolet irradiation pipes, the facility requiring four ultraviolet irradiation pipes is provided with one ultraviolet lamp unit including four ultraviolet irradiation pipes, and the facility requiring five ultraviolet irradiation pipes is provided with one ultraviolet lamp unit including five ultraviolet irradiation pipes. As described above, when four kinds of ultraviolet lamp units are produced according to two to five ultraviolet irradiation pipes, a production cost is high. For this reason, there is room for improvement in the point how the ultraviolet lamp units are provided to reduce the production cost.

An object of the present invention is to provide an ultraviolet water treatment device which can be easily introduced into the existing water treatment facility even when a water type or water quantity is changed, without requiring an expansion pipe, a reduction pipe, and a cross-sectional shape change and connection unit, in which it is possible to reduce a production cost.

### BRIEF DESCRIPTION OF THE DRAWINGS

FIG. 1 is a top view of an ultraviolet water treatment device according to a first embodiment.

FIG. 2 is a front view of the ultraviolet water treatment device viewed in a direction indicated by arrow Y of FIG. 1.

FIG. 3 is a side view of the ultraviolet water treatment device viewed in a direction indicated by arrow X of FIG. 1.

FIG. 4 is a diagram of a 3-lamp ultraviolet irradiation module in the embodiment.

FIG. 5 is a diagram of a 2-lamp ultraviolet irradiation module in the embodiment.

FIG. 6 is a diagram illustrating an example of specifications of a general medium pressure ultraviolet lamp.

FIG. 7 is a diagram illustrating an example of a dimension and flow quantity of a pipe in JIS standard.

FIG. 8 is a diagram illustrating combination of treatment flow quantity, a pipe inner diameter, and a lamp type and number in the embodiment.

FIG. 9 is a diagram of an ultraviolet water treatment device according to a second embodiment.

FIG. 10 is a diagram of an ultraviolet water treatment device according to a third embodiment.

FIG. 11 is a front view of an ultraviolet water treatment device of the related art.

FIG. 12 is a cross-sectional view taken along line X-X of FIG. 11.

### DETAILED DESCRIPTION

In general, according to one embodiment, an ultraviolet water treatment device of an embodiment includes an ultraviolet irradiation tank, a treated water supply inlet pipe, and a treated water discharge outlet pipe.

The ultraviolet irradiation tank includes a plurality of ultraviolet irradiation modules.

The plurality of ultraviolet irradiation modules include a plurality of ultraviolet irradiation pipes, a cleaning device, and a cleaning device driving unit.

The plurality of ultraviolet irradiation pipes include a plurality of ultraviolet lamps, and a plurality of ultraviolet lamp protective pipes individually protecting the ultraviolet lamps.

The cleaning device cleans a surface of each ultraviolet lamp protective pipe.

The cleaning device driving unit drives the cleaning device.

The inlet pipe has a center axis in a direction perpendicular to a center axis of each ultraviolet irradiation pipe and is connected to an end of the ultraviolet irradiation tank.

The outlet pipe is connected to the other end of the ultraviolet irradiation tank.

Each ultraviolet irradiation module includes two ultraviolet irradiation pipes or three ultraviolet irradiation pipes.

Hereinafter, embodiments will be described with reference to the drawings.

### First Embodiment

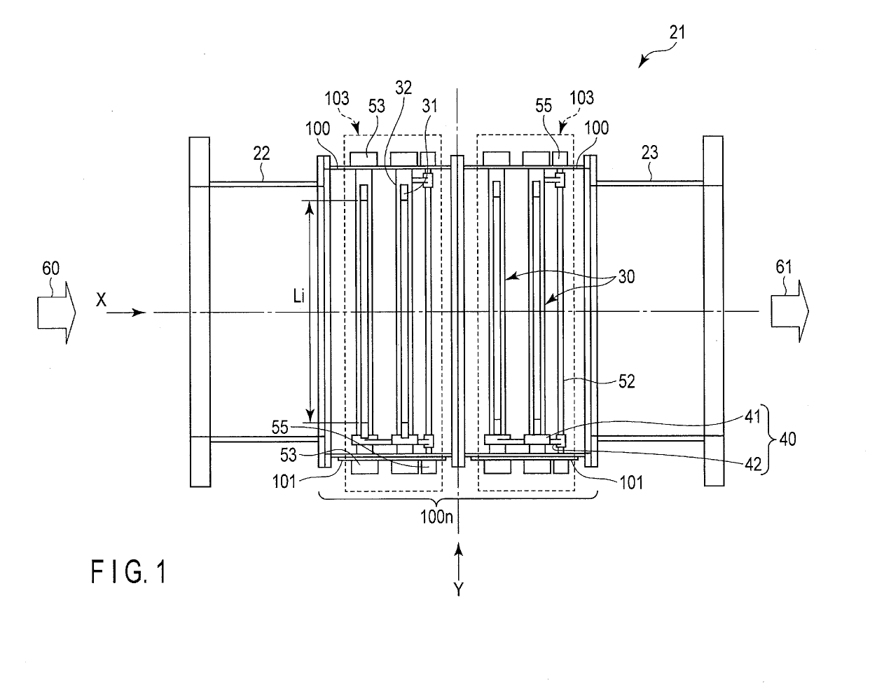

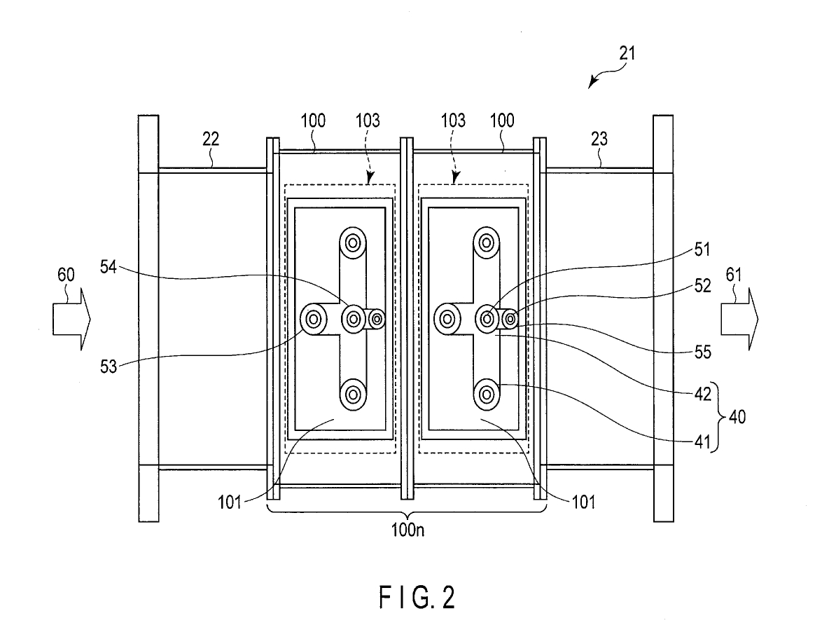

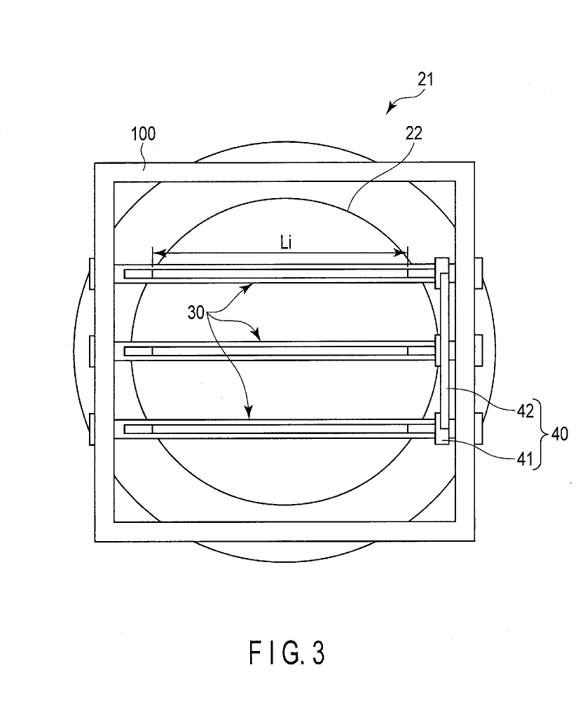

FIG. 1 is a top view of an ultraviolet water treatment device according to a first embodiment, and FIG. 2 is a front view of the ultraviolet water treatment device viewed in a direction indicated by arrow Y of FIG. 1. FIG. 3 is a side view of the ultraviolet water treatment device viewed in a direction indicated by arrow X of FIG. 1.

An ultraviolet water treatment device 21 is provided with a non-treated water supply inlet pipe 22, a treated water discharge outlet pipe 23 disposed on the same axis as that of the inlet pipe 22, and an ultraviolet irradiation tank 100n formed of a plurality of ultraviolet irradiation units 100.

The inlet pipe 22 and the outlet pipe 23 are on the same axis, and the inlet pipe 22 has a center axis in a direction perpendicular to a center axis of each ultraviolet irradiation pipe 30 and is connected to an end of the ultraviolet irradiation tank 100n.

The outlet pipe 23 is connected to the other end of the ultraviolet irradiation tank 100n.

The ultraviolet irradiation tank 100n is provided with a plurality (for example, two) of ultraviolet irradiation modules 103 that includes a plurality (for example, three) of ultraviolet irradiation pipes 30 including a plurality (for example, three) of ultraviolet lamps 31 and a plurality (for example, three) of ultraviolet lamp protective pipes 32 individually protecting the ultraviolet lamps 31, a cleaning device 40 cleaning a surface of each ultraviolet lamp protective pipe 32, and a cleaning device driving unit 50 driving the cleaning device 40. In this example, the ultraviolet irradiation tank 100n is formed of the plurality of ultraviolet irradiation units 100 in which the plurality of ultraviolet irradiation module 103 are individually incorporated, and the ultraviolet irradiation units 100 are integrally disposed in a line. In addition, the ultraviolet irradiation tank is not limited to the structure formed of the plurality of ultraviolet irradiation units, and may have an integral structure formed of pipes in which the ultraviolet irradiation modules are integrated as described in second and third embodiments.

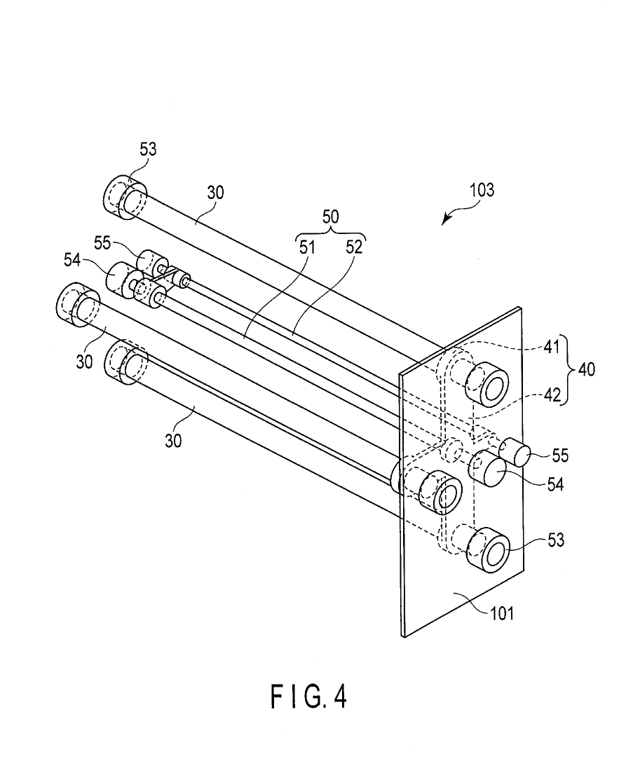

Herein, enlargement of the ultraviolet irradiation module 103 having three ultraviolet irradiation pipes 30 is illustrated in FIG. 4.

The ultraviolet irradiation units 100 have a box shape having a side with a length equal to or more than the outer diameter of the inlet pipe 22 or the outlet pipe 23, and are coupled by welding, and the vicinity of the coupled portion is rib-processed to reinforce the strength of the unit. In addition, since each ultraviolet irradiation unit 100 has the box shape, the ultraviolet irradiation tank 100n formed of the ultraviolet irradiation units 100 also has the box shape. In addition, the ultraviolet irradiation unit 100 is not limited to the box shape, and may be changed to a unit having a cylindrical shape having an inner diameter equal to or more than the outer diameter of the inlet pipe 22 or the outlet pipe 23.

The side face of one ultraviolet irradiation unit 100 is connected to the inlet pipe 22, and the side face opposite to the face connected to the inlet pipe 22 of the other ultraviolet irradiation unit 100 is connected to the outlet pipe 23. On the front face of each ultraviolet irradiation unit 100, an opening portion is provided to install each ultraviolet irradiation module 103. Each cover flange 101 of each ultraviolet irradiation module 103 is screw-fixed to the opening portion in a watertight structure by a watertight rubber packing (not illustrated) or the like. Accordingly, as necessary, each ultraviolet irradiation module 103 is detached such that the inside of each ultraviolet irradiation unit 100 is openable.

On each cover flange 101 (the front face) and the rear face of each ultraviolet irradiation unit 100, three ultraviolet lamp protective pipes 32, a screw-shaped cleaning device driving shaft (a rotation shaft) 51 moving the cleaning device 40, and a guide rail 52 are fixed in parallel (perpendicular to the center axes of the inlet pipe 22 and the outlet pipe 23) with the center axis of the ultraviolet irradiation unit 100 by the ultraviolet lamp (protective pipe) fixture 53, the driving shaft fixture 54, and the guide rail fixture 55, respectively.

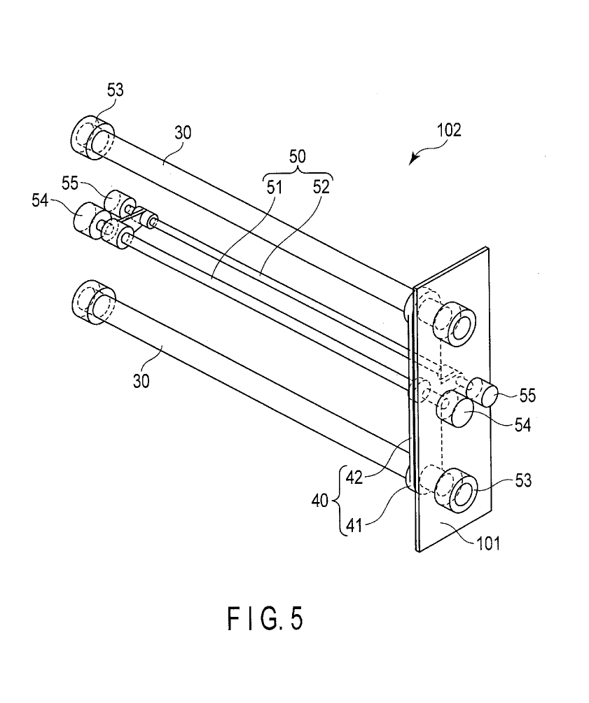

Herein, the ultraviolet irradiation module 102 having two ultraviolet irradiation pipes 30 is illustrated in FIG. 5. That is, each of the ultraviolet irradiation modules 102 and 103 has two ultraviolet irradiation pipes 30 or three ultraviolet irradiation pipes 30. In addition, from the view point of efficiently irradiating the ultraviolet ray, a length taken along the center axis of each ultraviolet irradiation pipe 30 is, for example, within the range of ±200 mm from the light emission length of each ultraviolet lamp 31, which is preferably equivalent to the light emission length of each ultraviolet lamp 31.

Differently from the number illustrated in FIG. 4, the ultraviolet irradiation module 102 includes two ultraviolet irradiation pipes 30 that has two ultraviolet lamps 31 and two ultraviolet lamp protective pipes 32 individually protecting each ultraviolet lamp 31, the cleaning device 40 that cleans a surface of each ultraviolet lamp protective pipe 32, and a cleaning device driving unit 50 that drives the cleaning device 40. Each ultraviolet irradiation unit 100 may be provided with the ultraviolet irradiation module 102 having two ultraviolet irradiation pipes 30 instead of the ultraviolet irradiation module 103 having three ultraviolet irradiation pipes 30. In addition, the ultraviolet irradiation module 103 (three ultraviolet irradiation pipes) and the ultraviolet irradiation module 102 (two ultraviolet irradiation pipes) may be provided respectively. In addition, in the embodiment, the ultraviolet irradiation unit 100 is configured by two stages, but the ultraviolet irradiation unit may be expanded to an arbitrary plurality of stages such as three stages, four stages, . . . , the module provided in each unit may be changed for each unit to the ultraviolet irradiation module 103 (three ultraviolet irradiation pipes) and the ultraviolet irradiation module 102 (two ultraviolet irradiation pipes).

That is, in the ultraviolet irradiation tank 100n, any one or both of the ultraviolet irradiation module 102 having two ultraviolet irradiation pipes 30 and the ultraviolet irradiation module 103 having three ultraviolet irradiation pipes 30 is incorporated.

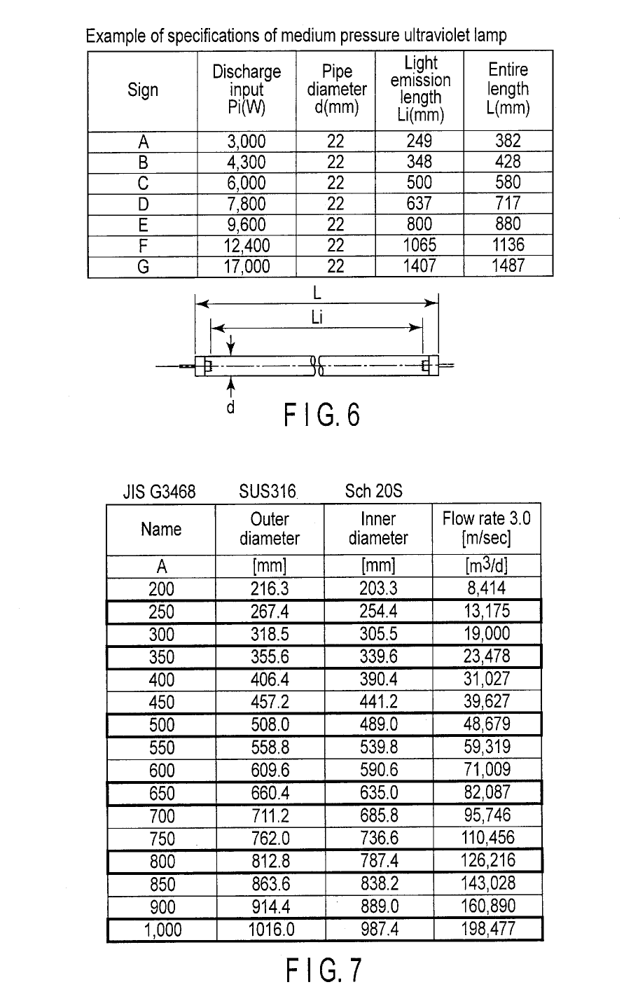

Next, a method of adopting the module and the ultraviolet lamp of the ultraviolet irradiation unit will be described. FIG. 6 illustrates an example of specifications of medium pressure ultraviolet rays. Discharge input power Pi is a power value supplied to the ultraviolet lamp. As the discharge input power Pi gets higher, the light emission length Li gets longer, and light-emitted ultraviolet power UVC gets higher.

Meanwhile, a diameter of a pipe used in the water treatment facility or the like is adopted such that the maximum water flow rate is about 2.5 to 3.0 [m/sec] generally considering treatment flow quantity and pressure loss reduction in the pipe. However, the inlet pipe 22 and the outlet pipe 23 of the embodiment having the inner diameter in which the flow rate is within the range of 2.5 to 3.5 [m/sec] with respect to the maximum treatment water quantity of the ultraviolet irradiation tank 100n is adopted. In FIG. 7, a dimension of a pipe regulated in JIS standard, and flow quantity at a flow rate of 3.0 [m/sec] are illustrated.

Each ultraviolet irradiation unit 100 is configured by combination of the ultraviolet lamps in which the water flow body inner diameter and the light emission length Li are equivalent, considering the water flow body as a standard product illustrated in FIG. 7, from the relation between the ultraviolet lamp illustrated in FIG. 6 and the pipe standard illustrated in FIG. 7. Specifically, for example, as the pipe (the inlet pipe 22 and the outlet pipe 23) of a nominal diameter 250 A and the lamp A, the pipe of 500 A and the lamp C, and the pipe (the inlet pipe 22 and the outlet pipe 23) of 1000 A and the lamp F, it is configured by combination in which the inner diameters of the inlet pipe 22 and the outlet pipe 23 and the light emission length are equivalent.

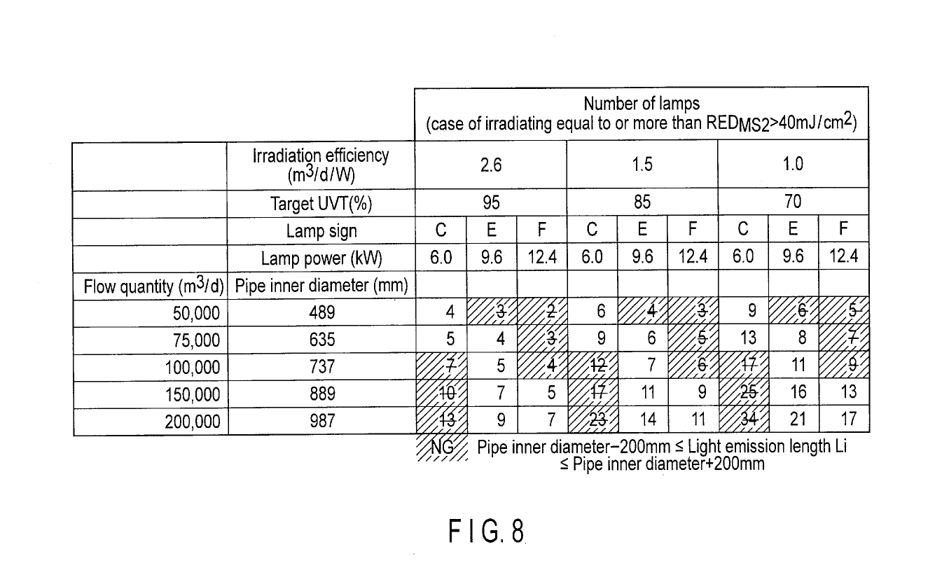

Next, in FIG. 8, the treatment flow quantity of the treatment target, the pipe (the inlet pipe 22 and the outlet pipe 23) inner diameter with the combination described above, and combination of the lamp type and number are illustrated.

In addition, in the embodiment, indicator bacteria (coliphage MS2) is irradiated with the ultraviolet ray, and difference in water quality is considered when installing the ultraviolet lamps 31 of the number of lamps in which reduction equivalent ultraviolet dose (RED) obtained by biologically converting the ultraviolet irradiation amount from the inactivation amount of the indicator bacteria is a value equal to or more than 40 [mJ/cm²]. The water quality means ultraviolet transmittance (UVT) of the treatment target water.

That is, the total number of lamps of the ultraviolet water treatment device 21 is different according to the treatment flow quantity, the water quality, and the power of the adopted lamps. For example, when the flow quantity is 50,000 to 200,000 m³/d, the ultraviolet transmittance (UVT) is equal to or more than 70%, and the adopted lamps are C, E, and F, it is necessary to provide 4 to 21 lamps.

Particularly, in the ultraviolet water treatment device for water purification, there are many cases where the ultraviolet transmittance (UVT) is designed equal to or more than 95%. In that case, 4 to 9 ultraviolet lamps 31 are combined. In addition, as the combination in which the inner diameters of the inlet pipe 22 and the outlet pipe 23 and the light emission length are equivalent, in the embodiment, the ultraviolet lamp in which the light emission length is in the range of ±200 mm of the pipe diameter is selected.

As described above, the ultraviolet irradiation module 103 (three ultraviolet irradiation pipes) and the ultraviolet irradiation module 102 (two ultraviolet irradiation pipes) are selected and incorporated in the ultraviolet irradiation unit 100 so as to be the predetermined number of lamps. In addition, in the embodiment, the reduction equivalent ultraviolet dose (RED) in which the indicator bacteria is the number of lamps in which the coliphage MS2 is the value equal to or more than 40 [mJ/cm²]. Also for the other bacteria, it is preferable to combine the ultraviolet irradiation module 103 (three ultraviolet irradiation pipes) and the ultraviolet irradiation module 102 (two ultraviolet irradiation pipes) so as to be the total number of lamps capable of irradiating the irradiation amount of the value equal to or more than the reduction equivalent ultraviolet dose obtained from the inactivation amount of the bacteria.

The cleaning device 40 includes a cleaning brush 41 that is provided to rub the surface of the ultraviolet lamp protective pipe 32, and a lamp protective pipe cleaning plate 42 that fixes the cleaning brush 41. The lamp protective pipe cleaning plate 42 is fixed in the box-shaped ultraviolet irradiation unit 100 through the cleaning device driving shaft 51 and the guide rail 52. The lamp protective pipe cleaning plate 42 has a female screw cut hole, and the screw-shaped cleaning device driving shaft 51 is coupled and fitted to the hole by a screw operation. That is, the lamp protective pipe cleaning plate 42 is coupled with the screw-shaped cleaning device driving shaft 51 by screw. The cleaning device driving shaft 51 is fixed to each cover flange 101 on the front face of each ultraviolet irradiation module 103 and the rear face of each ultraviolet irradiation unit 100, in a structure of rotating while keeping watertight with the driving shaft fixture 54. One end of the cleaning device driving shaft 51 is connected to the driving motor (not illustrated). Similarly, the guide rail 52 is fixed to the ultraviolet irradiation unit 100 by the guide rail fixture 55. When the driving motor rotates the cleaning device driving shaft 51 in a forward rotation direction and a backward rotation direction at a predetermined time interval, the lamp protective pipe cleaning plate 42 moves forward and backward along the cleaning device driving shaft 51 according to the screw operation based on the rotation. At this time, the cleaning brush 41 fixed to the lamp protective pipe cleaning plate 42 moves forward and backward along the lamp protective pipe 32 while rubbing the surface of the ultraviolet lamp protective pipe 32.

Next, an operation of the ultraviolet water treatment device configured as described above will be described.

The treated water 60 passes from the left side (the paper face front side of FIG. 3) of FIG. 1 and FIG. 2 while being irradiated with the ultraviolet rays of each ultraviolet irradiation unit 100, and flows out to the right side (the paper face rear side of FIG. 3) of FIG. 1 and FIG. 2, as treatment water 61. In addition, when the driving motor is driven, the screw-shaped cleaning device driving shaft 51 connected to the driving motor is rotated, the lamp protective pipe cleaning plate 42 mounted on the cleaning device driving shaft 51 is reciprocally operated in the ultraviolet irradiation unit 100 along the guide rail 52. As a result, the cleaning brush 41 fixed to the lamp protective pipe cleaning plate 42 is reciprocally operated while coming in contact with the ultraviolet lamp protective pipe 32, and thus the surface of the ultraviolet lamp protective pipe 32 is cleaned.

As described above, according to the first embodiment, by the configuration provided with the ultraviolet irradiation tank 100n formed of the plurality of ultraviolet irradiation unit 100 in which the plurality of ultraviolet irradiation modules 102 and 103 each having two ultraviolet irradiation pipes 30 or three ultraviolet irradiation pipes 30 are individually incorporated, it is possible to easily introduce the configuration into the existing water treatment facility even when the water type or water quantity is changed, without requiring the expansion pipe, the reduction pipe, and the cross-sectional shape change and connection unit, and it is possible to reduce the production cost.

In addition, according to the first embodiment, even in the facility requiring a number of ultraviolet irradiation pipes other than multiplies of 3, it is possible to cope by the combination of two kinds of ultraviolet irradiation modules 102 and 103 having two or three ultraviolet irradiation pipes 30, and thus it is possible to reduce the production cost. For example, in the related art, in the facility requiring two or five ultraviolet irradiation pipes, it is necessary to produce four kinds of ultraviolet lamp units according to two to five ultraviolet irradiation pipes, and thus the production cost is high. On the other hand, in the embodiment, in the facility requiring two to five ultraviolet irradiation pipes, two ultraviolet irradiation modules 102 having two ultraviolet irradiation pipes may be provided in the facility requiring four ultraviolet irradiation pipes, the ultraviolet irradiation module 102 having two ultraviolet irradiation pipes and the ultraviolet irradiation module 103 having three ultraviolet irradiation pipes may be provided in the facility requiring five ultraviolet irradiation pipes, and thus it is possible to reduce the production cost as compared with the related art.

Further, for example, the following effects (1) to (3) can be obtained.

(1) According to the first embodiment, the configuration is achieved by the ultraviolet lamp 31 in which the pipe inner diameter and the ultraviolet emission unit length are equivalent, the treated water 60 is irradiated with the ultraviolet ray generated from the ultraviolet lamp 31 without waste, and it is possible to contribute to disinfection (sterilization) of treated target substances of microorganisms, organic matters, or inorganic matters in the treated water 60 or oxidation treatment. In addition, according to the first embodiment, particularly, the number of units in which the ultraviolet module 103 of three ultraviolet irradiation pipes and two ultraviolet irradiation modules 102 are combined is merely changed, and thus it is possible to obtain a sufficient irradiation amount even when the total number of necessary lamps is any one of an odd number or an even number with respect to all the treatment conditions (the ultraviolet irradiation amount, the treatment flow quantity, the water quality (the ultraviolet transmittance (UVT) of the treatment target water)), as the target of the ultraviolet water treatment device 21.

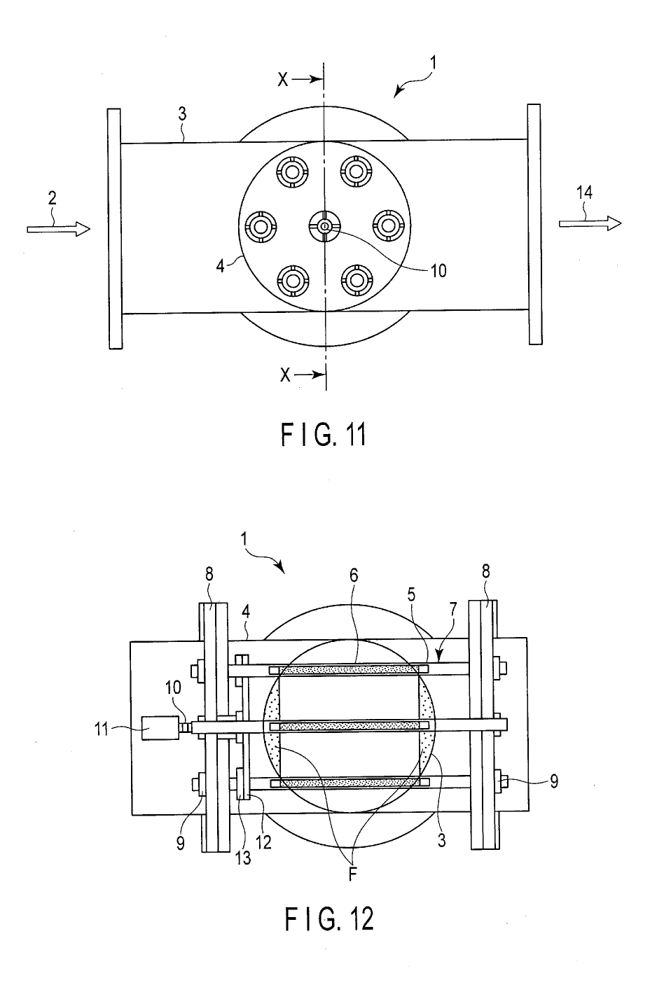

(2) FIG. 11 is a front view of the ultraviolet water treatment device using the medium pressure ultraviolet lamp, and FIG. 12 is a cross-sectional view taken along line X-X of FIG. 11. The ultraviolet water treatment device 1 includes a pipe-shaped water flow body 3 in which the treated water 2 flows, and a lamp housing 4 with the same pipe diameter as that of the pipe-shaped water flow body 3 joined to cross at the center portion of the pipe-shaped water flow body 3. The lamp housing 4 is provided with a lamp protective pipe 5 made of quartz glass, and six ultraviolet irradiation pipes 7 in which the ultraviolet lamp 6 is disposed in the protective pipe 5, at the same interval. Both end portions of each ultraviolet irradiation pipe 7 are water-sealed by a watertight O-ring (not illustrated) and an O-ring presser 9 in a lamp housing cover 8. In addition, in the lamp housing 4, a cleaning device including a screw-shaped cleaning plate driving shaft 10, a driving motor 11, a cleaning plate 12, and a lamp protective pipe cleaning wiper 13 is incorporated. In the ultraviolet water treatment device 1 with such a configuration, the ultraviolet lamps with the same specifications are used. In addition, a reference numeral “14” denotes treatment water.

In a case of the ultraviolet water treatment device illustrated in FIG. 11 and FIG. 12, the whole length of the ultraviolet lamp 6, and the light emission length and thickness are determined by power consumption (or the ultraviolet power) of the ultraviolet lamp 6 (FIG. 6). For this reason, in a case of a circular cross section such as the pipe-shaped water flow body, the width of the center line portion is the maximum, and gets tapered in an up and down direction of the cross section. For this reason, in a case of adopting the installed ultraviolet lamp 6, as illustrated in FIG. 12, when the adopting is performed according to the up and down position width of the cross section, the light emission length of the ultraviolet lamp 6 becomes short with respect to the water flow body width in the ultraviolet lamp 6 of the center position. As a result, the treated water 2 flowing in the both-end side area F of the ultraviolet lamp 6 is not sufficiently irradiated with the ultraviolet ray. In addition, on the contrary to the description, when the ultraviolet lamp 6 is adopted according to the width of the cross-sectional center portion of the pipe-shaped water flow body, the light emission length of the ultraviolet lamp 6 becomes long with respect to the width of the pipe-shaped water flow body in the cross-sectional upper portion and the cross-sectional lower portion. For this reason, the area which does not contribute to the treatment of the treated water 2 is also irradiated with the ultraviolet ray in vain.

On the other hand, in the first embodiment, the ultraviolet lamp 31 with the long light emission length (corresponding to the pipe diameter) is adopted in advance, the box-shaped unit larger than the pipe diameter is connected to the inlet pipe 22 and the outlet pipe 23, and thus it is possible to efficiently irradiate the treated water 60 with all the ultraviolet rays emitted from the ultraviolet lamps 31 to perform disinfection (sterilization) or oxidation treatment.

(3) Three or two ultraviolet lamps 31 and the cleaning device 40 are integrated as the ultraviolet irradiation module 103 (three ultraviolet irradiation pipes) or the ultraviolet irradiation module 102 (two ultraviolet irradiation pipes). The ultraviolet irradiation modules 103 and 102 are fixed to the ultraviolet irradiation units 100 by the cover flange 101, the ultraviolet lamp (protective pipe) fixture 53, the driving shaft fixture 54, and the guide rail fixture 55. Each ultraviolet irradiation module 100 may be drawn out for each of the cover flange 101 by only removing the fixtures 53 to 55, and thus it is easy to maintain the inside of the ultraviolet irradiation unit 100, particularly, the cleaning device 40. In addition, the ultraviolet irradiation module 103 (three ultraviolet irradiation pipes) or the ultraviolet irradiation module 102 (two ultraviolet irradiation pipes) is miniaturized by modularizing three or two ultraviolet irradiation pipes 30. For this reason, it is easy to draw the modules 102 and 103 out of the ultraviolet irradiation unit 100, and it is easy to maintain the inside of the unit, particularly, the cleaning device 40.

### Second Embodiment

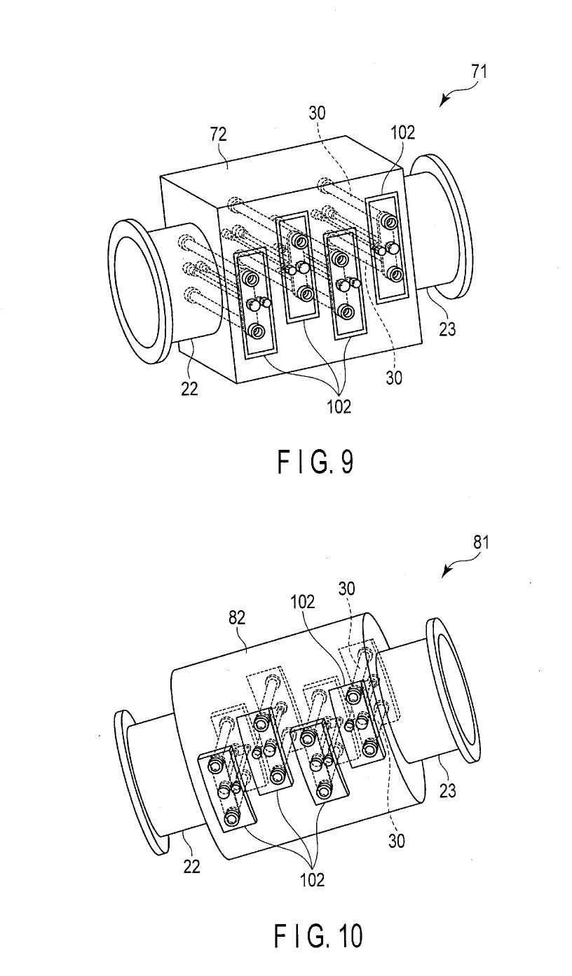

FIG. 9 is a diagram of an ultraviolet water treatment device according to a second embodiment, the same reference numerals and signs are given to the same portions as the drawings described above, detail description thereof is not provided, and the other portions will be mainly described herein. In addition, also in the following embodiment, the repeated description is not provided in such a manner.

The second embodiment is a modification example of the first embodiment, an ultraviolet water treatment device 71 is provided with an ultraviolet irradiation tank 72 in an integral structure formed of a rectangular pipe in which four ultraviolet irradiation modules 102 (two ultraviolet irradiation pipes) are incorporated, instead of the ultraviolet irradiation tank 100n formed of the ultraviolet irradiation units 100 illustrated in FIG. 1 to FIG. 5. The rectangular pipe has a box shape having a side with a length equal to or more than outer diameters of the inlet pipe 22 and the outlet pipe 23. Each ultraviolet irradiation module 102 is incorporated in the ultraviolet irradiation tank 72 such that positions in height of the ultraviolet irradiation pipes 30 deviate from each other. In addition, the number of incorporated ultraviolet irradiation modules 102 is not limited to four, and an arbitrary number of modules may be incorporated. In addition, some or all of the ultraviolet modules 102 may be replaced by the ultraviolet irradiation module 103 (three ultraviolet irradiation pipes). In addition, the position in height of each ultraviolet irradiation module 102 may be constant (for example, a position where the center axis of the ultraviolet irradiation module 102 intersects with the center axis of the inlet pipe 22 and the outlet pipe 23). Particularly, in the first embodiment, it is necessary to produce the plurality of ultraviolet irradiation units 100. In this case, when the height is constant, it is possible to a larger amount of units with the same shape, and thus it is possible to reduce the production cost.

According to the configuration described above, in addition to the effect of the first embodiment, it is not necessary to produce and weld the plurality of ultraviolet irradiation units 100, and thus it is possible to reduce the production process, and to reduce the production cost. Particularly, when the flow quantity is large, the pipe diameter of the low UVT is equal to or more than 1000 A, and the number of lamps is large, and when only the module is produced and the ultraviolet irradiation tank 72 is processed to fix the module, it is possible to shorten a production period, and it is possible to reduce the production cost.

In addition, by changing the heights of the ultraviolet irradiation modules 102 and 103, when the flow quantity is large, the pipe system of the low UVT is 1000 A, and the number of lamps is large, it is possible to irradiate the area of the upper portion and the lower portion of the ultraviolet irradiation tank 72 getting away from the ultraviolet lamp 31 with sufficient ultraviolet rays, and thus it is possible to improve treatment efficiency. As a result, it is possible to reduce a power cost and the total number of necessary lamps, and thus it is possible to reduce the production cost.

### Third Embodiment

FIG. 10 is a diagram of an ultraviolet water treatment device according to a third embodiment.

The third embodiment is a modification example of the first embodiment, an ultraviolet water treatment device 81 is provided with an ultraviolet irradiation tank 82 in an integral structure formed of a cylindrical pipe in which four ultraviolet irradiation modules 102 (two ultraviolet irradiation pipes) are incorporated, instead of the ultraviolet irradiation tank 100n formed of the ultraviolet irradiation units 100 illustrated in FIG. 1 to FIG. 5. The cylindrical pipe has a cylindrical shape having an inner diameter equal to or more than outer diameters of the inlet pipe 22 and the outlet pipe 23. Each ultraviolet irradiation module 102 is incorporated in the ultraviolet irradiation tank 82 such that positions in height of the ultraviolet irradiation pipes 30 deviate from each other. In addition, the number of incorporated ultraviolet irradiation modules 102 is not limited to four, and an arbitrary number of modules may be incorporated. In addition, some or all of the ultraviolet modules 102 may be replaced by the ultraviolet irradiation module 103 (three ultraviolet irradiation pipes). In addition, the position in height of each ultraviolet irradiation module 102 may be constant (for example, a position where the center axis of the ultraviolet irradiation module 102 intersects with the center axis of the inlet pipe 22 and the outlet pipe 23).

According to the configuration described above, in addition to the effect of the first embodiment, it is possible to use a cylindrical pipe of a general marketed product as the ultraviolet irradiation tank 82, and thus it is possible to shorten the production period, and to reduce the production cost.

In addition, similarly to the second embodiment, by changing the heights of the ultraviolet irradiation modules 102 and 103, when the flow quantity is large, the pipe system of the low UVT is 1000 A, and the number of lamps is large, it is possible to irradiate the area of the upper portion and the lower portion of the ultraviolet irradiation tank 82 getting away from the ultraviolet lamp 31 with sufficient ultraviolet rays, and thus it is possible to improve treatment efficiency. As a result, it is possible to reduce a power cost and the total number of necessary lamps, and thus it is possible to reduce the production cost.

According to at least one of the embodiments described above, by the configuration provided with the ultraviolet irradiation tank 100n, 72, or 82 in which the plurality of ultraviolet irradiation modules 102 and 103 each having two ultraviolet irradiation pipes 30 or three ultraviolet irradiation pipes 30 are individually incorporated, it is possible to easily introduce the configuration into the existing water treatment facility even when the water type or water quantity is changed, without requiring the expansion pipe, the reduction pipe, and the cross-sectional shape change and connection unit, and it is possible to reduce the production cost.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An ultraviolet water treatment device comprising:
an ultraviolet irradiation tank that is provided with a plurality of ultraviolet irradiation modules including a plurality of lines of ultraviolet irradiation pipes including a plurality of lines of ultraviolet lamps and a plurality of lines of ultraviolet lamp protective pipes individually protecting the ultraviolet lamps, a cleaning device cleaning a surface of each ultraviolet lamp protective pipe, and a cleaning device driving unit driving the cleaning device;
a treated water supply inlet pipe that has a center axis in a direction perpendicular to a center axis of each ultraviolet irradiation pipe and is connected to an end of the ultraviolet irradiation tank; and
a treated water discharge outlet pipe that is connected to the other end of the ultraviolet irradiation tank,
wherein each ultraviolet irradiation module includes two ultraviolet irradiation pipes or three ultraviolet irradiation pipes.

2. The ultraviolet water treatment device according to claim 1, wherein the ultraviolet irradiation tank is formed of a plurality of ultraviolet irradiation units in which the plurality of ultraviolet irradiation modules are individually incorporated, and the ultraviolet irradiation units are integrally disposed in a line.

3. The ultraviolet water treatment device according to claim 1, wherein the ultraviolet irradiation tank has an integral structure formed of a pipe in which the plurality of ultraviolet irradiation modules are integrated.

4. The ultraviolet water treatment device according to claim 1, wherein in the ultraviolet irradiation tank, any one or both of the ultraviolet irradiation module including two ultraviolet irradiation pipes and the ultraviolet irradiation module including three ultraviolet irradiation pipes is incorporated.

5. The ultraviolet water treatment device according to claim 1, wherein the ultraviolet irradiation tank has a box shape having a side with a length equal to or more than outer diameters of the inlet pipe and the outlet pipe.

6. The ultraviolet water treatment device according to claim 1, wherein the ultraviolet irradiation tank has a cylindrical shape having an inner diameter equal to or more than outer diameters of the inlet pipe and the outlet pipe.

7. The ultraviolet water treatment device according to claim 5, wherein a length taken along the center axis of each ultraviolet irradiation pipe is within a range of +200 mm from a light emission length of each ultraviolet lamp.

8. The ultraviolet water treatment device according to claim 1, wherein the inlet pipe and the outlet pipe have an inner diameter within a range in which a flow rate is 2.5 to 3.5 [m/sec] with respect to maximum treatment water quantity of the ultraviolet irradiation tank.

9. The ultraviolet water treatment device according to claim 1, wherein a light emission length of each ultraviolet lamp is within a range of ±200 mm with respect to the inner diameters of the outlet pipe and the inlet pipe.

10. The ultraviolet water treatment device according to claim 1, wherein the ultraviolet irradiation modules are incorporated in the ultraviolet irradiation tank such that positions in height of the ultraviolet irradiation pipes deviate from each other.
